(19) United States
(12) Patent Application Publication
(10) Pub. No.: US 2008/0273147 A1
(43) Pub. Date: Nov. 6, 2008

(54) Liquid crystal display device having black/white LCD panel

(75) Inventors: Man-Ho Kim, Suwon-si (KR); Seong-Ha Park, Suwon-si (KR); Joong-Wan Park, Suwon-si (KR)

Correspondence Address: CHA & REITER, LLC, 210 ROUTE 4 EAST STE 103, PARAMUS, NJ, 07652, US

(73) Assignee: Samsung Electronics Co., LTD.

(21) Appl. No.: 12/150,198

(22) Filed: Apr. 25, 2008

(30) Foreign Application Priority Data
May 3, 2007 (KR) 43105/2007

(51) Int. Cl. G02F 1/1335

(52) U.S. Cl. 349/106

(57) ABSTRACT

Disclosed is a Liquid Crystal Display (LCD) device including a black/white LCD panel for displaying an image, a color filter disposed on a rear surface of the black/white LCD panel in order to filter input light into light of preset colors and output the filtered light to the black/white LCD panel, and a back light unit having a plurality of optical sheets to output white light to the color filter. The color filter is integrated with one of the plurality of optical sheets as one piece.

### CLAIM OF PRIORITY

This application claims the benefit of the earlier filing date, under 35 U.S.C. § 119(a), to that Korean Patent Application filed in the Korean Intellectual Property Office on May 3, 2007 and assigned Serial No. 2007-43105, the entire disclosure of which is hereby incorporated by reference.

### BACKGROUND OF THE INVENTION

1. Field of the Invention

The present invention relates to a Liquid Crystal Display (LCD) device, and in particular, to an LCD device using a black/white LCD panel.

2. Description of the Related Art

A Liquid Crystal Display (LCD) device is well-known to be an alternative to a Cathode-Ray Tube (CRT) because of its low-voltage and low-power consumption. In particular, a Thin Film Transistor (TFT)-LCD device can realize high-quality, large-screen, and color-display that can be a match for the CRT. For this reason, the TFT-LCD device has been used in various fields of applications such as portable wireless terminals, e.g., portable phones and portable computers, video cameras, and the like.

The LCD device includes an LCD panel having a liquid crystal layer to display an image and a Back Light Unit (BLU) to provide light to the LCD panel. The LCD panel includes the liquid crystal layer and upper and lower glass substrates disposed above and below the liquid crystal layer to control the arrangement of liquid crystal molecules. The lower glass substrate includes TFTs and pixel electrodes, and the upper glass substrate includes a common electrode. The LCD panel further includes upper and lower polarization plates disposed above and below the liquid crystal layer to linearly polarize input lights. The polarization directions of the upper and lower polarization plates are orthogonal to each other.

Typically, the LCD panel can be divided into a color LCD panel and a black/white LCD panel according to whether or not the upper glass substrate includes color filters in addition to the common electrode. Since the black/white LCD panel has no color filter, it does not change the color of input light. A Red/Green/Blue (RGB) LCD includes a color LCD panel having RGB color filters and can implement a desired color for each pixel.

FIG. 1 illustrates a black/white LCD panel 100 of a conventional LCD device. As illustrated in FIG. 1, the LCD device includes the black/white LCD panel 100 and a back light unit (not shown) for inputting monochromatic light 140 to the black/white LCD panel 100. The monochromatic light 140 is acquired by mixing Red (R) light, Green (G) light, and Blue (B) light. The back light unit may include R, G, and B light emitting diodes. By mixing the R, G, and B lights emitted from the R, G, and B light emitting diodes, Amber (A) light can be acquired as illustrated in FIG. 1. While the input light 140 is marked separately as the R, G and B colors and the output light 150 is marked as the A color for convenience in understanding in FIG. 1, both the input light 140 and the output light 150 have the A color.

The black/white LCD panel 100 includes a liquid crystal layer 110, upper and lower glass substrates 120 and 125 for controlling the arrangement of liquid crystal molecules, and upper and lower polarization plates 130 and 135 for linear polarization. The lower glass substrate 125 includes TFTs and pixel electrodes, and the upper glass substrate 120 includes a common electrode. The black/white LCD panel 100 applies an electric field to the liquid crystal molecules using the TFTs and the pixel electrodes in order to change the arrangement of the liquid crystal molecules by means of the electric field, thereby controlling the intensity of light 150 that is output from the black/white LCD panel 100. The upper and lower polarization plates 130 and 135 each linearly polarize the input light and their polarization directions are orthogonal to each other.

Although the above-described LCD device can produce an image of preset colors using the black/white LCD panel having a lower-cost and simpler manufacturing process than that of a color LCD panel, the R, G, and B light emitting diodes are expensive and their driving characteristics are much different from one another, resulting in a need for a complex driving circuit and high power consumption.

### SUMMARY OF THE INVENTION

An aspect of the present invention is to provide a Liquid Crystal Display (LCD) device capable of achieving low cost, thin thickness, a simple driving circuit, and low power consumption in realizing an image of preset colors using a black/white LCD panel.

According to one aspect of the present invention, there is provided a Liquid Crystal Display (LCD) device including a black/white LCD panel for displaying an image, a color filter disposed on a rear surface of the black/white LCD panel in order to filter input light into light of preset colors and output the filtered light to the black/white LCD panel, and a back light unit having a plurality of optical sheets to output white light to the color filter. The color filter is integrated with one of the plurality of optical sheets as one piece.

The back light unit may include a light source for outputting the white light and a Light Guide Plate (LGP) for illuminating the black/white LCD panel while guiding light coupled thereinto by the light source by means of internal reflection. The plurality of optical sheets may include a reflecting sheet for reflecting light input from the LGP back to the LGP, a diffusing sheet for diffusing and transmitting the light input from the LPG, and a prism sheet for collecting and transmitting light input from the diffusing sheet.

The reflecting sheet may include a substrate and a reflecting coating layer formed on a top surface of the substrate, and the color filter may include a color ink layer formed in a rear surface of the substrate of the reflecting sheet.

The diffusing sheet may include a substrate and a diffusing dot layer formed on a top surface of the substrate, and the color filter may include a color ink layer formed on a rear surface of the substrate of the diffusing sheet.

The prism sheet may include a substrate and a plurality of prism or mounds formed to protrude from a top surface of the substrate, and the color filter may include a color ink layer formed on a rear surface of the substrate of the prism sheet.

The color filter may include a plurality of color ink layers printed to cover half of the rear surface of the substrate.

According to another aspect of the present invention, there is provided a Liquid Crystal Display (LCD) device including a first LCD panel for displaying an image, a black/white LCD panel disposed such that its rear surface faces a rear surface of the first LCD panel in order to display an image, a first color filter disposed between the first LCD panel and the black/white LCD panel in order to filter input light into light of preset colors and output the filtered light to the black/white LCD panel, and a back light unit including a plurality of optical sheets to output white light to the first color filter. The first color filter is integrated with one of the plurality of optical sheets of the back light unit as one piece.

### BRIEF DESCRIPTION OF THE DRAWINGS

The above and other features and advantages of exemplary embodiments of the present invention will be more apparent from the following detailed description taken in conjunction with the accompanying drawings, in which:

FIG. 1 illustrates a black/white Liquid Crystal Display (LCD) panel of a conventional LCD device;

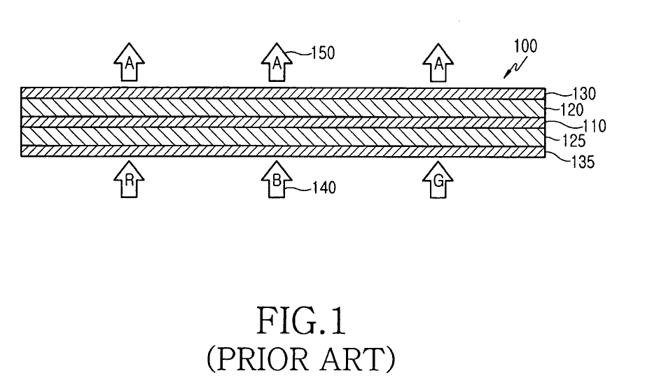

FIG. 2 illustrates an LCD unit of an LCD device according to the present invention;

FIG. 3 illustrates an LCD device according to a first exemplary embodiment of the present invention;

FIG. 4 illustrates an LCD device according to a second exemplary embodiment of the present invention;

FIG. 5 is a view for explaining integration of a color filter and an optical sheet according to the present invention;

FIG. 6 illustrates an LCD device according to a third exemplary embodiment of the present invention;

FIG. 7 illustrates an LCD device according to a fourth exemplary embodiment of the present invention; and

FIG. 8 illustrates an LCD device according to a fifth exemplary embodiment of the present invention.

Throughout the drawings, the same drawing reference numerals will be understood to refer to the same elements, features and structures.

### DETAILED DESCRIPTION OF THE INVENTION

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

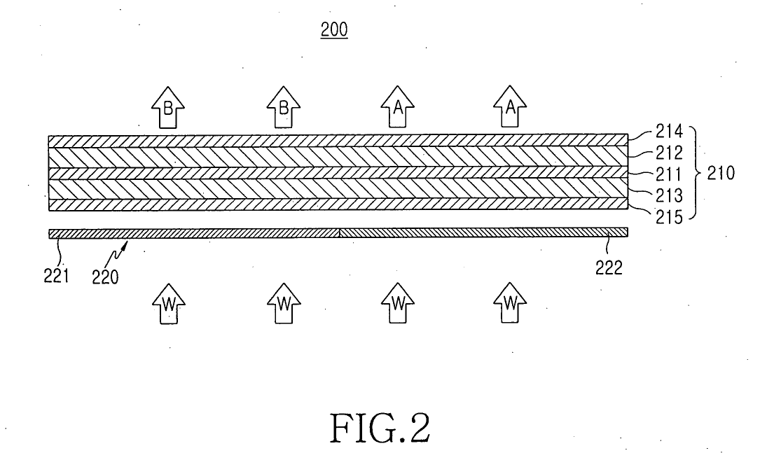

FIG. 2 illustrates an exemplary Liquid Crystal Display (LCD) unit 200 of an LCD device according to the present invention.

Referring to FIG. 2, the exemplary LCD device according to the present invention includes the LCD unit 200 for displaying an image and a back light unit (not shown) for outputting white (W) light. The LCD unit 200 includes a black/white LCD panel 210 having a liquid crystal layer to display an image and an external color filter 220 for filtering the W light input from the back light unit into light of preset colors and outputting the filtered light to the black/white LCD panel 210. In the present invention, the “black/white LCD panel” means an LCD panel having no color filter (internal color filter) corresponding to any one of three primary colors therein.

The black/white LCD panel 210 includes a liquid crystal layer 211, upper and lower glass substrates 212 and 213 for controlling the arrangement of liquid crystal molecules, and upper and lower polarization plates 214 and 215 to provide appropriate polarization. The lower glass substrate 213 is directly deposited on the bottom surface of the liquid crystal layer 211 and includes Thin Film Transistors (TFTs) and pixel electrodes. The upper glass substrate 212 is deposited on the top surface of the liquid crystal layer 211 and includes a common electrode. The black/white LCD panel 210 applies an electric field to the liquid crystal molecules using the TFTs and the pixel electrodes in order to change the arrangement of the liquid crystal molecules by means of the electric field, thereby controlling the intensity of light output from the black/white LCD panel 210. The upper polarization plate 214 is directly deposited on the top surface of the upper glass substrate 212, and the lower polarization plate 215 is directly deposited on the bottom surface of the lower glass substrate 213. The upper and lower polarization plates 214 and 215 each linearly polarize the input light and their polarization directions are orthogonal to each other.

The color filter 220 is disposed spaced apart from the bottom surface of the black/white LCD panel 210 and includes first and second filtering units 221 and 222 that are side-bonded in such a way to cover half of the entire area of the color filter 220. The first filtering unit 221 filters, for example, only Blue (B) light, and the second filtering unit 222 filters, for example, only Amber (A) light. The color filter 220 filters the input W light after halving the W light and outputs the filtered light to the black/white LCD panel 210. Since the light input to the black/white LCD panel 210 has not undergone color change, the light output from the black/white LCD panel 210 is in a state where it is divided into two colors; B and A. The black/white LCD panel 210 displays an image having two colors, B and A, on its top surface.

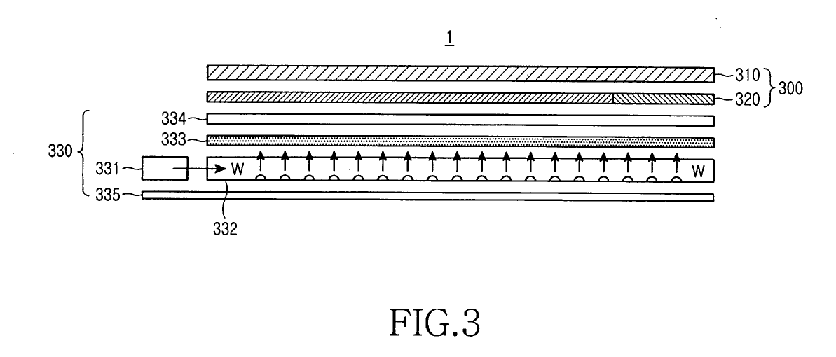

FIG. 3 illustrates an exemplary LCD device 1 according to a first embodiment of the present invention. In FIG. 3, a color filter according to the present invention is applied to a one-way LCD displaying an image in one way.

Referring to FIG. 3, the LCD device 1 includes an LCD unit 300 for displaying an image and a back light unit 330 for outputting W light.

The LCD unit 300 includes a black/white LCD panel 310 for displaying an image and a color filter 320 for filtering the W light input from the back light unit 330 into light of preset colors and outputting the filtered light to the black/white LCD panel 310. The black/white LCD panel 310 has the same structure as that of the black/white LCD panel 210 illustrated in FIG. 2 and thus need not be described in detail again. Similarly, color filter 320 has a structure as shown in FIG. 2 and need not be describe in detail again.

The back light unit 330 includes a light source 331, a Light Guide Panel (LGP) 332, and a plurality of optical sheets, for example, a reflecting sheet 335, a diffusing sheet 333, and a prism sheet 334.

The light source 331 outputs W light and may be a light emitting diode or a laser diode (LD).

The LGP 332 illuminates the black/white LCD panel 310 while guiding light coupled thereinto by the light source 331 by means of internal reflection. The LGP 332 includes a top surface and a bottom surface that face each other and first through fourth side surfaces. The first side surface faces the light emitting surface of the light source 331. The LGP 332 guides light coupled thereinto through the first side surface towards the second side surface disposed to face the first side surface by means of internal reflection between the top surface and the bottom surface.

The LGP 332 includes a plurality of dot patterns that are formed substantially uniformly over the entire LGP 332. A portion of light diffused by each of the dot patterns is reflected towards the top surface of the LGP 332 and the remaining portion of the diffused light penetrates the bottom surface of the LGP 332. In other words, each dot pattern destroys the internal reflection condition at an interfacial surface between the LGP 332 and an external air layer, thereby causing the light diffused by each dot pattern to penetrate the top surface and the bottom surface of the LGP 332. Each dot pattern may be in various edge forms such as a circle, an oval, a square, a lozenge (rhombus), and the like, or may be formed in the form of intaglio (printmaking) (or a groove) or embossment (or a protrusion) on the bottom surface of the LGP 332. Alternatively, each dot pattern may be separately formed as a protrusion and then be attached onto the bottom surface of the LGP 332. Preferably, each dot pattern may be implemented as a hemispherical groove. In one aspect of the invention, each dot pattern may be implemented as a scattered reflection pattern such as a scratch.

As the light traveling into the LGP 332 is attenuated while moving from the first side surface adjacent to the light source 331 towards the second side surface, luminance distribution on the top surface of the LGP 332 takes on an aspect where luminance gradually decreases from the first side surface towards the second side surface. To solve the luminance non-uniformity problem, the density of dot patterns may increase from the first side surface towards the second side surface. The density of dot patterns may be changed by changing the number of dot patterns or the size of each dot pattern, and can be defined as an area occupied by dot patterns per unit area.

The reflecting sheet 335 is disposed spaced apart from the LGP 332 such that the top surface of the reflecting sheet 335 faces the bottom surface of the LGP 332. The reflecting sheet 335 reflects input light that has penetrated the bottom surface of the LGP 332 back into the LGP 332. The reflecting sheet 335 preferably may have a full mirror of nearly 100% reflectivity, but it may also have lower reflectivity.

The diffusing sheet 333 is disposed spaced apart from the LGP 332 such that the bottom surface of the diffusing sheet 333 faces the top surface of the LGP 332. The diffusing sheet 333 diffuses and transmits light input from the LGP 332.

The prism sheet 334 is disposed spaced apart from the diffusing sheet 333 such that the bottom surface of the substrate of the prism sheet 334 faces the top surface of the diffusing sheet 333. The prism sheet 334 includes a plurality of prisms or mounds formed to protrude from the top surface of the substrate of the prism sheet 334. The prism sheet 334 collects and transmits light input from the diffusing sheet 333.

The color filter 320 is disposed spaced apart from the prism sheet 334 such that the bottom surface of the color filter 320 faces the top surface of the prism sheet 334. The color filter 320 selectively transmits only light in a particular wavelength band. The color filter 320 filters W light input from the prism sheet 334 into light of preset colors and outputs the filtered light to the black/white LCD panel 310. Since the light input to the black/white LCDP panel 310 has not undergone color change, the black/white LCD panel 310 displays an image having the preset colors on its top surface.

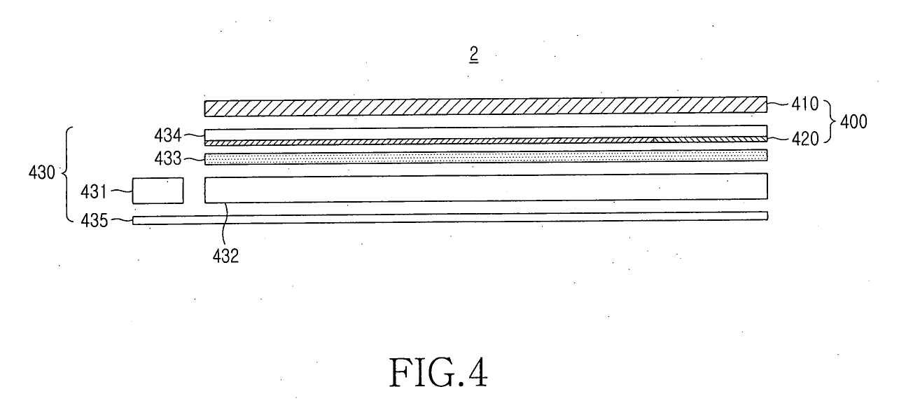

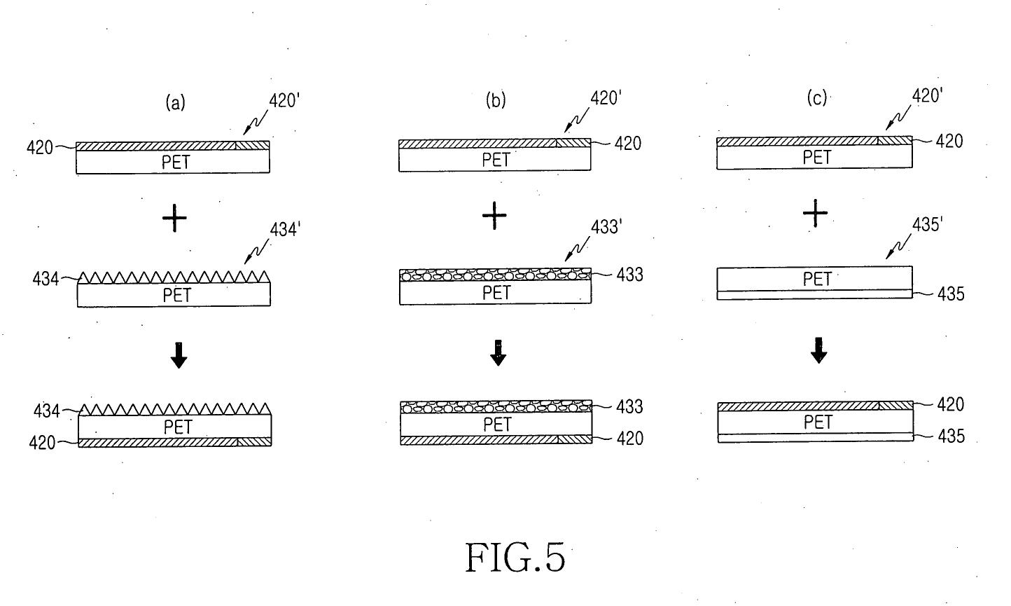

FIG. 4 illustrates an exemplary LCD device 2 according to a second embodiment of the present invention, and FIG. 5 is a view for explaining integration of a color filter and an optical sheet according to the present invention.

Referring to FIG. 4, the LCD device 2 includes an LCD unit 400 for displaying an image and a back light unit 430 for outputting W light. The LCD unit 400 includes a black/white LCD panel 410 for displaying an image and a color filter 420 for filtering the W light input from the back light unit 430 into light of preset colors and outputting the filtered light to the black/white LCD panel 410. The black/white LCD panel 410 has the same structure as that of the black/white LCD panel 210 illustrated in FIG. 2, and thus will not be described in detail again. The back light unit 430 includes a light source 431, an LGP 432, and a plurality of optical sheets, for example, a reflecting sheet 435, a diffusing sheet 433, and a prism sheet 434.

The LCD device 2 has a structure that is similar to that of the LCD device 1 illustrated in FIG. 3 except that the color filter 420 is integrated with the prism sheet 434 as one piece without being separated from the prism sheet 434. Thus, the same structure as in FIG. 3 will not be described in detail.

Referring to figure (a) of FIG. 5, a color filter 420′ includes a polyethylene terephthalate (PET) substrate and a color ink layer 420 formed on the top surface of the PET substrate. A prism sheet 434′ includes a PET substrate and a plurality of prisms or mounds 434 formed to protrude from the top surface of the PET substrate. Referring to figure (b) of FIG. 5, a color filter 420′ includes a polyethylene terephthalate (PET) substrate and a color ink layer 420 formed on the top surface of the PET substrate. A diffusing sheet 433′ includes a PET substrate and a diffusing dot layer 433 formed on the top surface of the PET substrate. Referring to figure (c) of FIG. 5, a color filter 420′ includes a polyethylene terephthalate (PET) substrate and a color ink layer 420 formed on the top surface of the PET substrate. A reflecting sheet 435′ includes a PET substrate and a reflecting coating layer 435 formed on the top surface of the PET substrate. That is, the color filter 420′ and the optical sheets 433′, 434′, and 435′ all include the PET substrates (for convenience, the PET substrates will not be shown in the other figures except for FIG. 5).

While the thickness of each PET substrate is usually several tens of micrometers (50-100 μm), the thickness of each of the color ink layer 420, the prisms 434, the diffusing dot layer 433, and the reflecting coating layer 435 is usually several micrometers (5-10 μm). Thus, the color ink layer 420 is formed on the PET substrates of the optical sheets 433′, 434′, and 435′ in order to share the PET substrates in order to integrate the optical sheets 433′, 434′, and 435′ with the color filter 420, thereby reducing the thickness of the LCD device 2 by the thickness of the PET substrates.

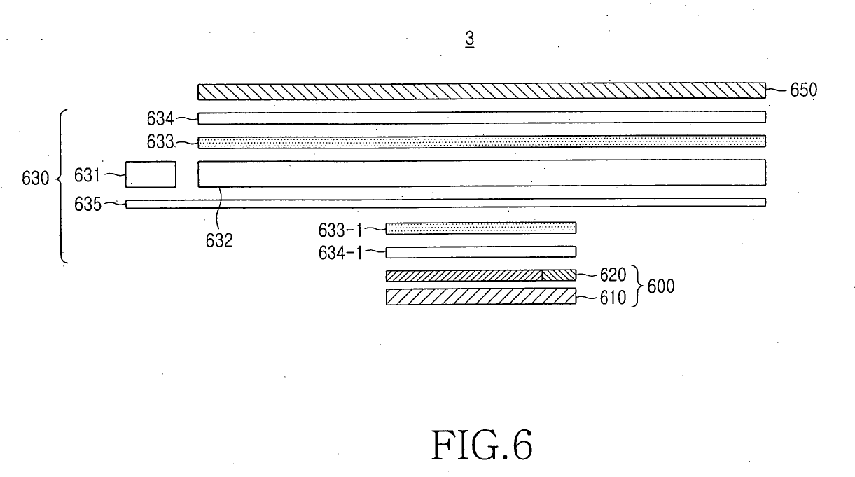

FIG. 6 illustrates an exemplary LCD device 3 according to a third embodiment of the present invention. In FIG. 6, the structure of an external color filter according to the present invention is applied to a side, e.g., a sub LCD unit, of a two-way LCD device for displaying an image in two ways. The LCD device 3 has a structure that is similar to that of the LCD device 1 illustrated in FIG. 3 except that the LCD device 3 further includes a second diffusing sheet 633-1, a second prism sheet 634-1, and a second LCD panel 632-1.

Referring to FIG. 6, the LCD device 3 includes a main LCD unit 650 (or a first LCD unit) for displaying an image, a sub LCD unit 600 (or a second LCD unit), and a back light unit 630 for outputting W light. The main LCD unit 650 includes a color LCD panel having a color filter corresponding to three primary colors therein. The sub LCD unit 600 includes a black/white LCD panel 610 and a color filter 620 for filtering the W light input from the back light unit 630 into light of preset colors and outputting the filtered light to the black/white LCD panel 610.

The color LCD panel includes a liquid crystal layer, upper and lower glass substrates for controlling the arrangement of liquid crystal molecules, upper and lower polarization plates for linear polarization, and the color filter corresponding to three primary colors. Since the light input to the color LCD panel from the first prism sheet 634 penetrates the color filter, the color LCD panel displays an image of preset colors on its top surface. While the main LCD unit is implemented as a color LCD panel to display a color image in the current exemplary embodiment of the present invention, it may also be implemented as a black/white LCD panel.

The back light unit 630 includes a light source 631 for outputting the W light, an LGP 532 for illuminating the color LCD panel and the black/white LCD panel 600 while guiding the light internally by means of internal reflection, a reflecting sheet 635 for reflecting a portion of the light output below the bottom surface of the LGP 632 back to the LGP 632, first and second reflecting sheets 633 and 633-1, and first and second prism sheets 634 and 634-1.

The LGP 632 has a top surface and a bottom surface that face each other, and first through fourth side surfaces. The first side surface faces the light emitting surface of the light source 631. The LGP 632 guides the light coupled thereinto through the first side surface towards the second side surface disposed to face the first side surface by means of internal reflection between the top surface and the bottom surface. The LGP 632 has a plurality of dot patterns formed substantially uniformly over the entire bottom surface. A portion of light diffused by each dot pattern is reflected towards the top surface of the LGP 632 and the remaining portion of the diffused light penetrates the bottom surface of the LGP 632. In other words, each dot pattern destroys the internal conditions at the interfacial surfaces between the LGP 632 and an external air layers, thereby causing the light diffused by each dot pattern to penetrate the top surface and the bottom surface of the LGP 632.

The reflecting sheet 635 is disposed spaced apart from the LGP 632 such that the top surface of the reflecting sheet 635 faces the bottom surface of the LGP 632. The reflecting sheet 635 reflects a portion of input light that has penetrated the bottom surface of the LGP 632 back into the LGP 632 and transmits the remaining portion of the input light into the second diffusing sheet 633-1. Preferably, the reflecting sheet 635 has a reflectivity of 50-80%.

The first diffusing sheet 633 is disposed spaced apart from the LGP 632 such that the bottom surface (or substrate) of the first diffusing sheet 633 faces the top surface of the LGP 632. The first diffusing sheet 633 diffuses and transmits the light input from the LGP 632.

The first prism sheet 634 is disposed spaced apart from the first diffusing sheet 633 such that the bottom surface of the substrate of the first prism sheet 634 faces the top surface of the first diffusing sheet 633. The first prism sheet 634 includes a plurality of prism or mounts formed to protrude from the top surface of the substrate of the first prism sheet 634. The first prism sheet 634 collects and transmits the light input from the first diffusing sheet 633.

The second diffusing sheet 633-1 is disposed spaced apart from the reflecting sheet 635 such that the bottom surface of the second diffusing sheet 633-1 faces the bottom surface of the reflecting sheet 635. The second diffusing sheet 633-1 diffuses and transmits the light input from the LGP 632.

The second prism sheet 634-1 is disposed spaced apart from the second diffusing sheet 633-1 such that the top surface of the substrate of the second prism sheet 634-1 faces the bottom surface of the substrate of the second diffusing sheet 633-1. The second prism sheet 634-1 includes a plurality of prism or mounds formed to protrude from the bottom surface of the second prism sheet 634-1. The second prism sheet 634-1 collects and transmits the light input from the second diffusing sheet 633-1.

The color filter 620 is disposed spaced apart from the second prism sheet 634-1 such that the top surface of the color filter 620 faces the prism or mounds of the second prism sheet 634-1. The color filter 620 transmits only light of preset lights. The color filter 620 filters the W light input from the second prism sheet 634-1 into light of preset colors and outputs the filtered light to the black/white LCD panel 610.

The black/white LCD panel 610 is disposed spaced apart from the color filter 650 such that the top surface of the black/white LCD panel 610 faces the bottom surface of the color filter 650. The black/white LCD panel 610 includes upper and lower glass substrates for controlling the arrangement of liquid crystal molecules and upper and lower polarization plates to provide for appropriate polarization. Since the light input to the black/white LCD panel 610 has not undergone color change, the black/white LCD panel 610 displays an image of preset colors on its bottom surface.

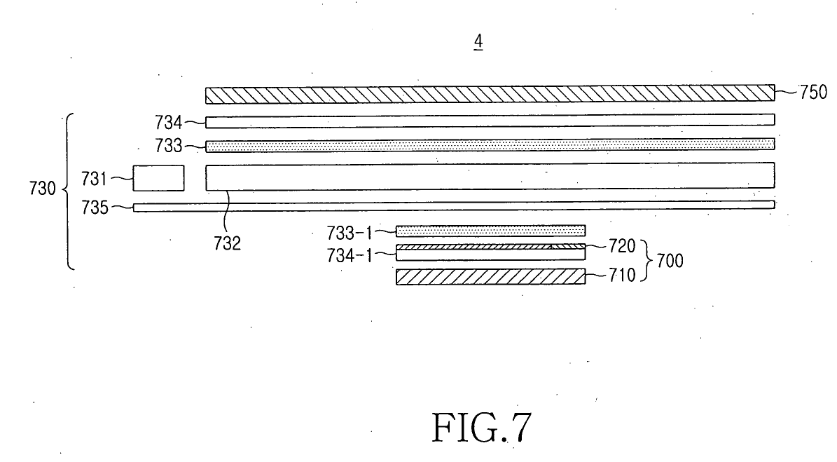

FIG. 7 illustrates an exemplary LCD device 4 according to a fourth embodiment of the present invention.

Referring to FIG. 7, the LCD device 4 includes a main LCD unit 750, a sub LCD unit 700, and a back light unit 730 for outputting W light.

The main LCD unit 750 includes a color LCD panel having a color filter corresponding to three primary colors therein. The sub LCD unit 700 includes a black/white LCD panel 710 and a color filter 720 for filtering the W light input from the back light unit 730 into light of preset colors and outputting the filtered light to the black/white LCD panel 710. The back light unit 730 includes a light source 731 for outputting the W light, a LGP panel 732 for illuminating the color LCD panel 750 and the black/white LCD panel 700 while guiding light coupled thereinto by the light source 731 by means of internal reflection, a reflecting sheet 735 for reflecting a portion of the light output below the bottom surface of the LGP 732 back to the LGP 732, first and second diffusing sheets 733 and 733-1, and first and second prism sheets 734 and 734-1.

The LCD device 4 has a structure that is similar to that of the LCD device 3 illustrated in FIG. 6 except that the external color filter 720 applied to the sub LCD unit 700 is integrated with the second prism sheet 734-1 as one piece without being separated (or spaced apart) from the second prism sheet 734-1.

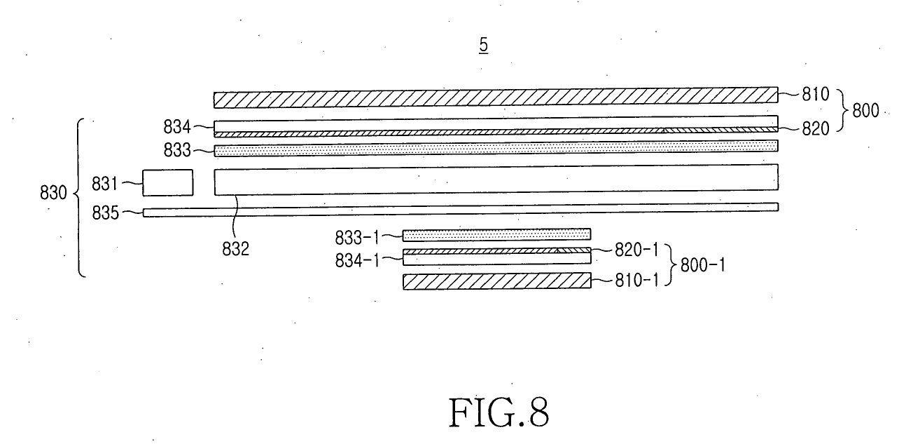

FIG. 8 illustrates an LCD device 5 according to a fifth exemplary embodiment of the present invention. In FIG. 8, an external color filter integrated with an optical sheet is applied to both a main LCD unit and a sub LCD unit.

Referring to FIG. 8, the LCD device 5 includes a main LCD unit 800 and a sub LCD unit 800-1 for displaying an image and a back light unit 830 for outputting W light. The main LCD unit 800 includes a black/white LCD panel 810 and an external color filter 820 for filtering the W light input from the back light unit 830 into light of preset colors and outputting the filtered light to the black/white LCD panel 810. The sub LCD unit 800-1 includes a black/white LCD panel 810-1 and an external color filter 820-1 for filtering the W light input from the back light unit 830 into light of preset colors and outputting the filtered light to the black/white LCD panel 810-1. The back light unit 830 includes a light source 831 for outputting the W light, an LGP 832 for illuminating the black/white LCD panels 810 and 810-1 while guiding the light coupled thereinto by the light source 831 by means of internal reflection, a reflecting sheet 835 for reflecting a portion of the light output below the bottom surface of the LGP 832 back to the LGP 832, first and second diffusing sheets 833 and 833-1, and first and second prism sheets 834 and 834-1.

The LCD device 5 has a structure that is similar to that of the LCD device 3 illustrated in FIG. 7 except that both the main LCD unit 800 and the sub LCD unit 800-1 include the black/white LCD panels 810 and 810-1 and the external color filters 820 and 820-1, respectively.

While the invention has been shown and described with reference to exemplary embodiments thereof, it will be understood by those skilled in the art that various changes in form and details may be made therein without departing from the spirit and scope of the invention.

What is claimed is:

1. A Liquid Crystal Display (LCD) device, comprising:
a black/white LCD panel for displaying an image;
a color filter disposed on a rear surface of the black/white LCD panel in order to filter input light into light of preset colors and output the filtered light to the black/white LCD panel; and
a back light unit having a plurality of optical sheets to output white light to the color filter,
wherein the color filter is integrated with one of the plurality of optical sheets as one piece and comprises at least one color ink layers printed on the rear surface of the substrate.

2. The LCD device of claim 1, wherein the black/white LCD panel comprises:
upper and lower glass substrates for controlling the arrangement of liquid crystal molecules; and
upper and lower polarization plates for linear polarization.

3. The LCD device of claim 1, wherein the back light unit comprises:
a light source for outputting the white light; and
a Light Guide Plate (LGP) for illuminating the black/white LCD panel while guiding light coupled thereinto by the light source by means of internal reflection.

4. The LCD device of claim 3, wherein the plurality of optical sheets comprise:
a reflecting sheet for reflecting light input from the LGP back to the LGP;
a diffusing sheet for diffusing and transmitting the light input from the LPG; and
a prism sheet for collecting and transmitting light input from the diffusing sheet.

5. The LCD device of claim 4, wherein the reflecting sheet comprises:
a substrate; and
a reflecting coating layer formed on a top surface of the substrate.

6. The LCD device of claim 4, wherein the diffusing sheet comprises:
a substrate; and
a diffusing dot layer formed on a top surface of the substrate.

7. The LCD device of claim 4, wherein the prism sheet comprises:
a substrate; and
a plurality of prisms formed to protrude from a top surface of the substrate.

8. A Liquid Crystal Display (LCD) device, comprising:
a first LCD panel for displaying an image;
a black/white LCD panel disposed such that its rear surface faces a rear surface of the first LCD panel in order to display an image;
a first color filter disposed between the first LCD panel and the black/white LCD panel in order to filter input light into light of preset colors and output the filtered light to the black/white LCD panel; and
a back light unit including a plurality of optical sheets to output white light to the first color filter, wherein the first color filter is integrated with one of the plurality of optical sheets of the back light unit as one piece and comprises at least one color ink layers printed on the rear surface of the substrate.

9. The LCD device of claim 8, wherein the back light unit comprises:
a light source for outputting the white light;
a Light Guide Plate (LGP) for illuminating the first LCD panel and the black/white LCD panel while guiding light coupled thereinto by the light source by means of internal reflection;
a reflecting sheet for reflecting a portion of light input from the LGP back to the LGP and transmitting the remaining portion of the input light;
first and second diffusing sheets for diffusing and transmitting the light input from the LGP; and
first and second prism sheets for collecting and transmitting light input from the first and second diffusing sheets.

10. The LCD device of claim 9, wherein the first LCD panel is a color LCD panel or a black/white LCD panel.

11. The LCD device of claim 10, wherein the first LCD panel is a black/white LCD panel, and comprises a second color filter disposed between the first LCD panel and the LGP of the back light unit in order to filter the input light into light of preset colors and output the filtered light to the first LCD panel.

12. The LCD device of claim 11, wherein the second color filter is integrated with one of the plurality of optical sheets of the back light unit.

13. The LCD device of claim 3, wherein the LGP includes a plurality of protrusions distributed substantially uniformly therethrough.

14. The LCD device of claim 3, wherein the LGP includes a plurality of protrusions distributed such that a density of said protrusions increases in the direct of propagation of light.

15. The LCD device of claim 9, wherein the LGP include a plurality of protrusions distributed substantially uniformly therethrough.

16. The LCD device of claim 9, wherein the LGP includes a plurality of protrusions distributed such that a density of said protrusions increases in the direct of propagation of light.

17. The LCD device of claim 3, wherein said light source is positioned opposite a first side of the LGP for directing light toward a second side of the LGP, said second side being opposite the first side.

18. The LCD device of claim 9, wherein said light source is positioned opposite a first side of the LGP for directing light toward a second side of the LGP, said second side being opposite the first side.

19. A Liquid Crystal Display (LCD) device, comprising:
a black/white LCD panel for displaying an image;
a color filter comprising a plurality of color ink layers printed on the rear surface of a substrate disposed on a rear surface of the black/white LCD panel in order to filter input light into light of preset colors and output the filtered light to the black/white LCD panel; and
a back light unit comprising a light source for outputting the white light and a Light Guide Plate (LGP) for illuminating the black/white LCD panel while guiding light coupled thereinto by the light source by means of internal reflection, said light source being positioned opposite a first side surface of said LGP for directing light through said LGP to a second side surface of said LGP, said second side surface being opposite said first side surface.

20. The device of claim 19, wherein said second side surface is a reflecting surface.
